(19) United States
(12) Patent Application Publication
(10) Pub. No.: US 2017/0124604 A1
(43) Pub. Date: May 4, 2017

(54) Crowd-funding Appraisals

(71) Applicant: Rute J. Hill, Chicago, IL (US)

(72) Inventor: Rute J. Hill, Chicago, IL (US)

(21) Appl. No.: 14/931,683

(22) Filed: Nov. 3, 2015

(51) Int. Cl. G06Q 30/02; G06Q 10/06; G06Q 30/08; G06Q 30/06; G06Q 50/00; G06Q 40/08

(52) U.S. Cl. CPC G06Q 30/0279; G06Q 50/01; G06Q 40/08; G06Q 30/08; G06Q 30/0643; G06Q 10/063112

(57) ABSTRACT

A method for crowd funding the desirability of a human subject's physical attributes on a social network is provided. In one embodiment of the invention, registered users on the social network provide data through valuation scorecards, wherein one or more processors determine the estimated cash value of any given physical characteristic input on the system based on crowd wisdom. A selection feature of a plurality of scoring options for soliciting crowd funding from the pool of users is presented on the display of a users computing device. In response to a user selecting one or more of the plurality of scoring options depicting any given human subject within the user's proximity, a summary of his/her credentials is presented as appraisal certificates/reports to the system conclusive of all the data available on the server to solicit various users to crowd fund the registration of the human subject and her preferred humanitarian causes, wherein the original user and the subject model share in a portion of the profits donated from the pool of users upon accommodating various requests. The result of the subject models registration onto the system concludes the pool of users who crowd funded, the user himself and the model all share in the model's future career earnings on the system.

### BACKGROUND

Field of the Invention

The present invention generally relates to web based social network communication, and more particularly to methods for crowdfunding humanitarian causes utilizing the documentation, assessment and recruitment of human subjects with desirable physical qualities.

Description of the Related Art

Crowdfunding is the practice of funding a project or venture by raising monetary contributions from a large number of people, today often performed via internet-mediated registries, but the concept can also be executed through mail-order subscriptions, benefit events, and other methods. Crowdfunding is a form of alternative finance, which has emerged outside of the traditional financial system The inputs of the individuals in the crowd trigger the crowdfunding process and influence the ultimate value of the offerings or outcomes of the process. Each individual acts as an agent of the offering, selecting and promoting the projects in which they believe. They will sometimes play a donor role oriented towards providing help on social projects. In some cases they will become shareholders and contribute to the development and growth of the offering. As of 2012 there were over 450 crowd funded platforms, from internet platforms that enable small companies to issue shares over the internet and provide small returns on the investments; to curating network platforms that curate the offerings that are offered on the platform.

### STATEMENT OF THE OBJECTS

Embodiments of the present invention comprise methods for crowdfunding humanitarian causes utilizing the desirability of a human subjects physical attractiveness. Additional advantages may be recognized by those of ordinary skill in the art upon study of the present disclosure.

An objective of the invention is to raise money for humanitarian causes.

A further objective of the invention is to provide a user-curated model-agency, wherein the users can earn money by discovering, documenting, crowd funding the registration of human subjects based upon the network's demand.

A further objective of the invention is to allow users of the network to raise money for, or crowd find the recruitment of models.

Another objective of the invention is to allow models to improve their demand and overall appeal to the masses based upon user preferences and likes/dislikes.

Another objective of the invention is to help recruit newer models by creating reports of models' income potential on the platform.

A further objective of the invention is to allow users of the network to assess pictures and videos of desirable human subjects/models.

A further objective of the invention is to allow users to generate appraisals certificates of human physical attributes that create desire and interest.

Other objects and advantages of the present invention will be set forth in part in the description and in the drawings that follow and, in part, will be obvious from the description or may be learned by practice of the invention.

### SUMMARY

To achieve the foregoing objects, and in accordance with the purpose of the invention as broadly described herein, the present invention provides methods for crowdfunding physical attractiveness utilizing a social network setting and allowing the members to attain financial gains using crowdfunding or user based donation technology. Reference in the specification to one embodiment or an embodiment means that a particular feature, structure or characteristic described in connection with the embodiment is included in at least one embodiment of the invention. The appearance of the phrase “in one embodiment” in various places in the specification do not necessarily refer to the same embodiment.

One aspect of one embodiment of the current invention allows a user to discover an actual human subject/model with desirable physical attributes and inputting the physical attributes into a scorecard along with uploading videos and pictures into the system; the system generating a digital appraisal certificate/report; the system then communicates to various other users; the users donating to solicit the original user requesting more footage and then begin assessing the footage and comparing it to the scorecard, to then comment and or begin to crowdfund to solicit the originating user to accommodate the desires of the crowdfunding users which may include additional footage or requesting the initial user to approach the actual subject with the real time donations displayed on the system; and requesting that the actual subject/model register onto the system to receive a share of the crowd finding.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The present invention will now be described with reference to the following drawings, in which like reference numbers denote the same element throughout.

FIG. 1 is an exemplary screen shot of the user's social network system as it relates to the login screen

FIG. 2 is an exemplary screen shot of a portion of the user's social network system as related to one embodiment of the system.

FIG. 3 provides flow chart illustrating logic that may be used when implementing preferred embodiments of the current invention.

FIG. 4 provides a flowchart illustrating logic that may be used when implementing preferred embodiments of the current invention.

### DETAILED DESCRIPTION

Embodiments of the present invention are described more fully below with reference to the accompanying drawings, which form a part hereof, and which show exemplary embodiments for practicing the invention. However, embodiments may be implemented in many different forms and should not be construed as limited to the embodiments set forth herein; rather these embodiments are provided so that this disclosure will be thorough and complete, and will fully convey the scope of the invention to those skilled in the art. The following detailed description is, therefore, not to be taken in the limiting sense.

The present invention is described below with reference to flowchart illustrations and/or block diagrams of methods according to embodiments of the invention. It will be understood that each block of the flowchart illustrations and/or block diagrams, and combinations of blocks in the flowchart illustrations and/or block diagrams, can be implemented by computer program instructions, these computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram.

The intent of this disclosure, while discussing exemplary embodiments, is that the following detailed description be construed to cover all modifications, alternatives, and equivalents of the embodiments as may fall within the spirit and scope of the invention as defined by the appended claims. It is to be understood and appreciated that the process steps and structures described herein do not cover a complete process flows. The present invention may be practiced in conjunction with various techniques that are conventionally used in the art, and only so much of the commonly practiced process steps are included herein as are necessary to provide an under standing of the present invention.

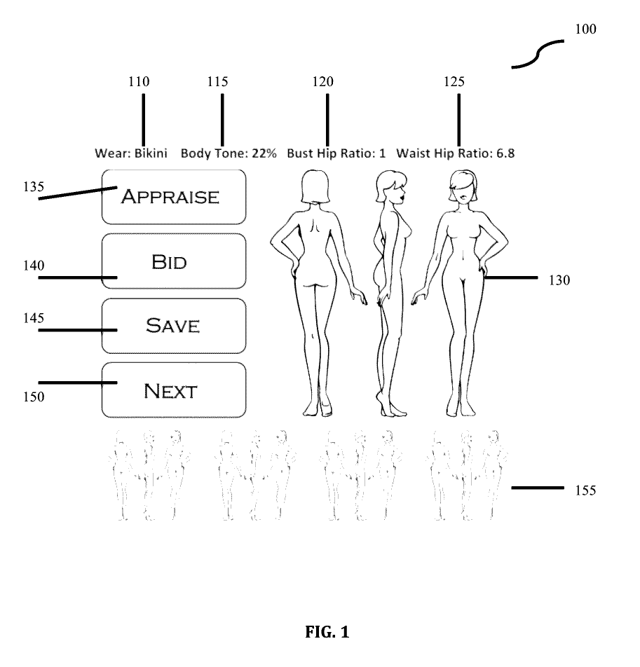

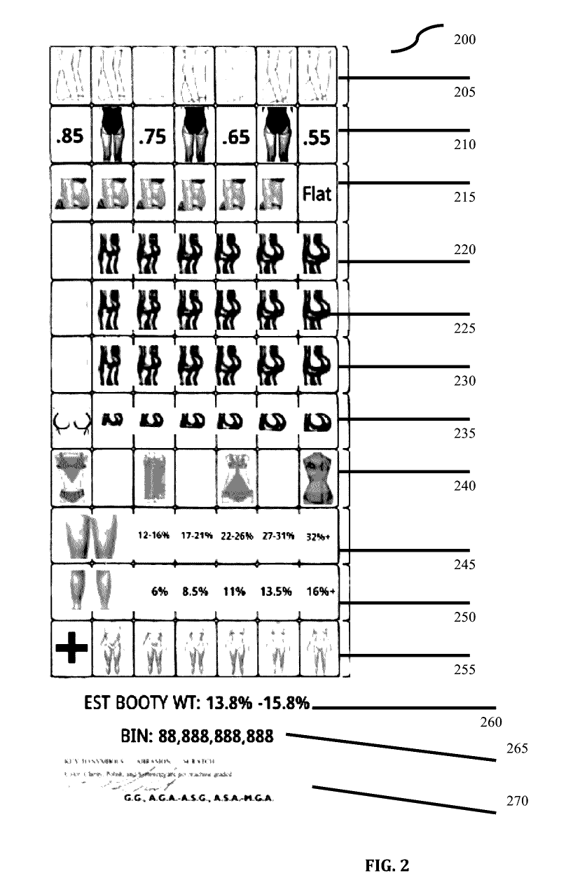

Referring now to the figures, FIG. 1 is an exemplary screen shot of the user's social network system as it relates to the login screen. A social network can refer to a computer network connecting entities, such as people or organizations, by a set of social relationships, such as friendship, co-working, or information exchange. Of course, a social network can refer to a computer application or data connecting such entities by such social relationships. In one embodiment of the invention, once a user registers, he can log into the system, 100. Upon registering, a user will be prompted to create a profile. Each profile within a social network for example, can contain entries, and each entry can comprise information associated with a profile. Examples of entries for a person profile can comprise contact information such as an email addresses, mailing address, IM name, or phone number; personal information such as relationship status, birth date, age, children, ethnicity, religion, political view, sense of humor, sexual orientation, fashion preferences, smoking habits, drinking habits, pets, hometown location, passions, sports, activities, favorite books, music, TV, or movie preferences, favorite cuisines; professional information such as skills, career, or job description; photographs of a person or other graphics associated with an entity; or any other information describing, identifying, or otherwise associated with a profile. Once a user logs in and registers, he is taken to fill out a scorecard that identifies the user's preferred model attributes wherein the system can notify the user upon the attributes being identified by other users of the system, which will be described more in detail in FIG. 2. At the top of the screen for FIG. 1, are displayed physical attributes that the user considers as attractive in a human subject. For example, what the user wants the human subject to wear, 110, what the user perceives as a good body tone, 115, what the user perceives as a good bust-hip ratio, 120, what the user perceives as a good waist-hip ratio, 125, are all displayed for the user to see. In addition the user's virtual model with the specific traits 110, 115, 120, 125 is also displayed for the user to see, 130. The system 100 also displays trending live models and virtual models, 135 matching the users preferences 110, 115, 120, 125. Based upon the trending models 135, the users may then choose to appraise one of the models. When a user selects the appraise button, 135, the system, 100, displays one or more videos of the model, 135, taking his/her measurements as well as him/her in three different preferred postures. Based upon this information, from the footage, the user then goes onto to score the model using assessment tools within the system, 100. The appraise button, 135, can also be linked on other social media platforms such as Youtube, Facebook, etc. that allows viewing of the models official profile by clicking the link associated with her own personal profile's appraisal page. This link will allow viewers to follow the model and become a member which will pay fees to the model/human subject along with the user that discovered her, the users that funded her registration onto the system as well as users with the highest bids to receive a portion of said model's career earnings for a forty five days, and the new user can bid and recruit new models immediately.

After viewing and appraising the model, using the scorecard screen within the system, the user can then choose to bid, 140, on the human subject/model. The bidding options include either booking the human subject, an in person meeting/option to date, or to share in the models' earnings from the system, 100. The option to share in the models earnings may also be known as an investor bid. With an investor bid, the user can opt to share a fraction of the model's earnings for a 45-day period.

Moving along, the next option a user can choose is to save, 145, wherein the user can store the data for further review later on. Or the user can simply opt to move along with the next button, 155, and review more human subjects or models, 135.

FIG. 2 is an exemplary screen shot of an embodiment of the system, as it relates to the scorecard screen, 200. Once a user registers he is taken to the scorecard screen, 200, where he can rank from most preferred to least preferred proportions on the human body and rank the importance of the preference overall. For example, once he opens the screen he can choose his most-to-least preferred lower vertebral wedge angle for a subject, 205. He can then further go on to choose his most-to-least preferred waist/hip ratio on a subject, 210. Moving along, he can choose his most-to-least preferred proportion of belly fat on a subject, 215. He can then choose his most-to-least preferred proportions of bottom of buttocks the subject, 220, A user can go on to choose his most-to-least preferred proportion of side of the exterior buttocks on the subject, 225, as well as choose the his most-to-least preferred proportion of buttocks depth, 230. He can choose his most-to-least preferred breast proportions, 235. He can also select his most-to-least preferred body shape, 240, his most-to-least preferred thigh weight, 245, and his most-to-least preferred calf weight, 250. He can then go on to choose his most-to-least preferred body tone on a subject, 255. Based upon all of these selections the user will then be alerted when human subjects with one or more of his highest (preferences has been submitted to the server by one or more users. When the user is done choosing, the system, 100, then goes onto combine all these choices and compiles a user's own preferred virtual human subject that is then utilized in a pool of data to determine the crowd wisdom of the system to deliver additional statistical information to models and their recruiters. He is prompted to disclose recommendations for his least preferred selections on his scorecard to be auto populated in appraisal reports completed on subjects. He then discloses what humanitarian causes he/she would like to donate some of the generated money he will help raise.

The 7×11 selection buttons FIG. 2 account for values totaling a sum of 88 possible. Of the 88 possible points, 64 points account for higher concentrations of weight in the gluteal region while 24 of the 88 points (other regions OR) account for amounts that displace the weight from the buttocks to other weight concentrations in the female body. The following algorithm determines the booty weight percentage:

(64 GCR−24 OR)=40(0.345 to 0.395)% (sum of the first 6 rows+sum of 8th and 11th row)−(sum of 7th, 9th and 10th rows)×(0.345 to 0.395)=13.8% to 15.8% as the total booty weight percentage of total body weight.

64−24=40

40×0.345=13.8

40×0.395=15.8

13.8% to 15.8% is the estimated percentage of total weight of the buttocks of a model scoring all 8's out of the 11 regions of the Booty Weight Appraisal. Multiply the percentage to get the quantity in pounds. For a model weighing 125 lbs with all 8's: 17.25 lbs to 19.75 lbs is her estimated buttocks weight.

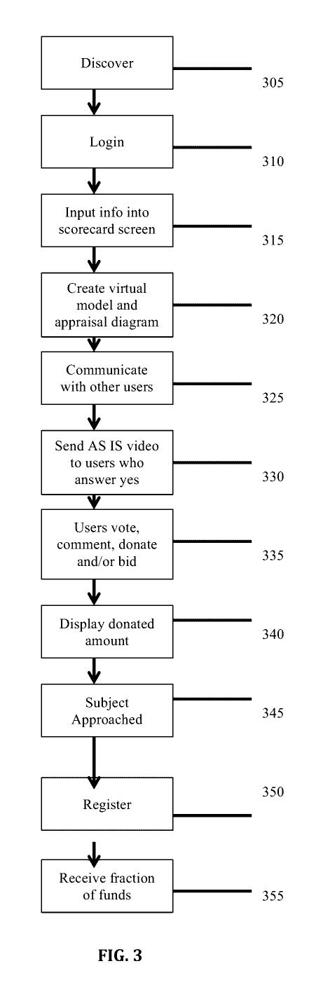

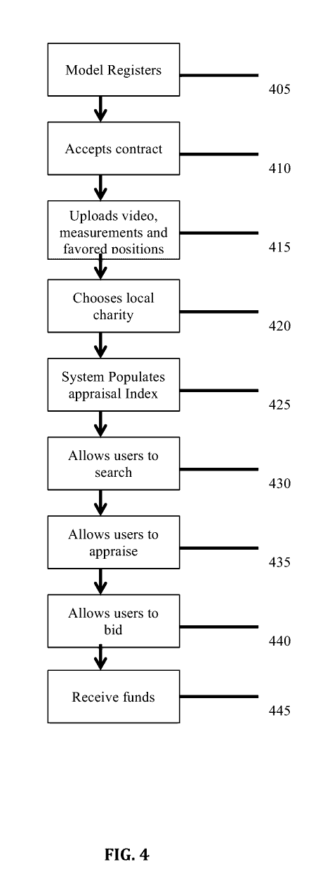

It should be noted that the present invention might comprise systems having different architecture than that which is shown in FIG. 1. The screen, 200, shown in FIG. 2 is merely exemplary, and is used to help explain the social networks and methods illustrated in FIGS. 3-4.

FIG. 3 is a process flow chart of an embodiment of the invention detailing how the invention works to recruit potential subjects and/or models. A user, recruiter or scout discovers, 305, a human subjects/model with the networks most preferred attributes, the user logs into the system, 310 and inputs, 315, the model's attributes using buttons from the scorecard screen 200 above which will deduct money from his user account and notify other users whose preferences match the subject's scorecard. The user will upload photos and/or videos that justify his scorecard selections as well as footage of the model highlighting the crowdfunding users preferences. Once the user is done choosing his choices on the scorecard screen, 200, it will result in the creation, 320, of a virtual model along with generating a digital appraisal certificate/report. The photos and footage may also be attached to the appraisal report/certificate. Such an entry into the system 100, will results in notifying, 325, the other online users, who have subscribed to this user or have set to notifications about one or more attributes selected by the identifying user regarding the model. Such other users will be notified to crowdfund giving them rights to portions of the model's career earnings upon her registration and additional footage as well, funding users can vote, comment and deliver interview questions to be answered upon registration, 330, with the optional picture/video of the real human subject attached. The users may also crowdfund to see additional ‘as-is’ footage of the real subject. Such information, primarily the crowdfunded money for the model/subject will be displayed on the original user's phone, 335, in real time. The user may then use this real time information to solicit the model to register on the network, 340. If the human subject/model then chooses to register on the network, 345, not only is he/she able to receive a portion of the crowdfunding displayed on the appraisal screen, 350, but in addition further gains for him/her include, but not limited to, receiving gifts and/or celebrity/surplus insurance and lines of credit by accepting challenges, dates, bookings, mental physical and spiritual regiments, fashion and wardrobe make overs, and providing endorsements, all at the models discretion to enhance his/her overall health, beauty, fitness entertainment and lifestyle. In addition, the system, 100, also gives the human subject/model the ability to donate the monies displayed to a chosen local charity. Furthermore, the finder/scout will also be provided a finder's fee, which is a certain percentage of the overall money raised for the model/human subject at the time of registration, 345. If the model chooses not to register she can still receive a portion of the populated funds in exchange for additional footage to be delivered to various users on the network. If the scout/recruiter chooses not to approach the subject, he may still deliver footage to one or more users on the system in exchange for a portion of the populated funds upon the funding users consent.

FIG. 4 is a flow chart of an exemplary embodiment of the current invention. A model can choose to register, 405, on the social network system, either individually or by a scout/recruiter finding her. If he/she registers due to a scout finding him/her, a preliminary profile will then be populated on the system, 100, utilizing Near Field Communication (NCF) technology to provide the model with a percentage of the donated amount displayed to his/her by the scout. The model will then properly register by signing the Model Agency contract, 410. Upon signing this contract the model agrees to provide the following, 415: one or more videos which will include up to three twerk postures and complete an optional Twerk Appraisal that will show off the funding-users' preferred aspects of the model and create a higher demand for her on the network, taking before or “as is” measurements of preferred physical embodiments. These desirable aspects are concluded by the tally of preferences of th users who funded the registration of the model. The system, 100, gauges this by determining what 3 postures are most favored by users while they are filling out the scorecard screen, 200. The system, 100, then tallies up these results, sees which users are crowdfunding certain model, and displays to the model the most preferred postures that those users would like to see the model twerk or pose in.

At the stage of the human subject registration, the model is prompted to disclose one or more humanitarian causes he/she would like to donate portions of her earnings to 420. The model's profile will then be fully active and the system, 100, will then populate an her attributes codified number or model index number, 425, that will represent the model's physical characteristics along with an Index Number that will assist other users to search, 430, based on their preference. Furthermore, the model also has the option to further populate his/her profile with entries such as lifestyle, love, monetary aspirations along with current challenges, diet regimens, solicitations she may accommodate etc. This is will allow the users to better to get to know the models as unique persons as well determine who they will crowdfund.

The system, 100, then allows the user's to view the model's physical attributes and footage, 415, when they hit the appraise button, 435. While viewing the attributes and footage, 415, the users can use the scoring features within the appraisal screen to score the models. These score can get be converted into cash values by the system. Furthermore, these scores and cash values can be outputted by the system in the form of appraisal certificates/reports, which can then be utilized by the models to get lines of credit and celebrity/surplus insurance on her preferred physical embodiments as voted upon or decided by the users of the system, 100.

If a user likes what he sees, the user can then choose to bid, 440, on a respective model. Models in receipt of bids, can receive the funds generated, 445, in exchange of accommodating the highest bidders at the models discretion.

The system provides the highest bidder various opportunities to interact directly with the model, which may include but not limiting to, soliciting model, meeting the model in person, or to receive the rights to portions of the models earnings for a determined period of time. The models earnings may come in various forms, such as: earnings from registering on the network; earnings from appraisals performed on her; typical model bookings or photo shoots, earning from users paying for custom performances and to see further footage of the model; earnings from user choosing to receive certain model perks-such as in person meetings, meeting at formal events, or simply spending time with a user. Various fees can be attached to all these options. On the other end, the models can also make money by recruiting more models.

Users can also make money from the website in various ways, for example they can make money by finding and recruiting other models, winning bids to earn a certain percentage of the model's earnings, managing the models upon whom the users have won a bid upon by having them recruit further models, accurately scoring and assessing models using the appraisal tools.

Models who get the highest scores or the highest bids will be indoctrinated in the “Hall of Fame.” The “Hall of Fame” indicates what physical attributes in a model are most desirable by users and may serve as a motivator for other models on the system to refine their lifestyle, diet, activities etc. in order to be able to attain the same attributes and be a crowd favorite. Moreover, the system can further generate income reports stating the models' earning potentials based upon features such as their appraisal scores, bid statistics etc., which can then be utilized as recruitment tools for further new models, and can provide th original model with the opportunity to earn a finder's fee. Furthermore, models can utilize the system to apply for a line of credit and then pay back the credit via any money generated during their time on the system. Moreover, models can also download the app to simply generate an Appraisal Certificate/Report, which will include a prescribed course of treatment, way of life, or diet for the promotion or restoration of health, to attain specific goals of the model based on the compilation of data compiled from various recommendations from the appraising users. These appraisal reports can then be utilized for celebrity/surplus insurance purposes, such as insuring the model's most preferred physical attributes as voted upon by the users of the system.

Although the above operational flow is described in a sequential manner, in other embodiments some operations may be performed in different orders or concurrently. Also, although the invention has been described in language specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer implemented method of crowdfunding using appraisal certificates/reports depicting cash values scoring the desirability of human characteristics in human subjects for financial gains comprising:
a. a user identifying physical attributes that create interest or desire in the human subject;
b. the user logging into the social network system;
c. the user making selections on a scorecard that identifies physical attributes of the subject based upon the subject identified;
d. a social network system creating a virtual model based upon the physical attributes selected;
e. the social network system generating one or more appraisal certificates/reports; and
f. one or more users crowdfunding to solicit the identifying user; and
g. one or more users crowdfunding the identifying user to solicit the human subject.

2. The method of claim 1, wherein the physical attributes include preferences determined by scorecards created by various users;

3. The method of claim 1, wherein the system notifies other users subscribed to receive notifications from the original user;

4. The method of claim 4, wherein the system notifications are determined by one or more scorecards created by the users;

5. The method of claim 1, wherein the system allows users responses to contribute to the generated appraisal certificates/reports, in real time;

6. The method of claim 1, wherein the system allows users to crowdfund to review footage of the human subject/model;

7. The method of claim 6, wherein the crowdfunding shows up in real time on the generated appraisal certificates/reports;

8. The method of claim 7, wherein the user can display to the human subject the generated appraisal certificate/report;

9. The method of claim 8, wherein the human subject can choose to register onto the system;

10. The method of claim 9, wherein registering includes the subject entering information regarding his/her physical measurements as well as uploading one or more videos of him/herself;

11. The method of claim 1, further comprising appraising of the human subject by the users;

12. The method of claim 11, wherein users perform an evaluation of the physical attributes of the subject;

13. The method of claim 11, wherein users score the physical attributes of the subject using assessment tools;

14. The method of claim 13, wherein the system displays the scores as cash values for each individual subject in appraisal reports;

15. The method of claim 14, wherein the appraisal certificates/reports can be utilized to apply for celebrity/surplus insurance for the preferred physical attributes by the model;

16. The method of claim 1, further comprising bidding upon the model by other users of the system;

17. The method of claim 15, wherein one or more users with the highest bids has the option to earn profits from any earnings the model makes from the system;

18. The method of claim 15, wherein the model with the highest scores can be indoctrinated into the hall of fame.

19. A computer implemented method for documenting a human subject with desirable attributes to inspire crowdfunding, for the users' financial gains, comprising:
a. allowing a user to create a virtual model of a real human subject with physical features causing interest or desire, wherein the real subject had been discovered by the user;
b. displaying the virtual model to other users along with optional pictures/videos of the actual human subject;
c. allowing one or more users on the system to donate to the original user;
d. allowing various subscribed users to donate to review further ‘as is’ videos of the human subject;
e. displaying one or more appraisal certificates/reports with the crowdfunded amount to the real human subject;
f. allowing the real human subject to register;
g. allowing the user to receive a portion of the donated amount as a finders fee;
h. allowing one or more other users to solicit the real human subject through one or more bids; and
i. allowing one or more highest bidders the opportunity to share in the career earnings of the real human subject on the system.

20. A computer implemented method of crowdfunding using one or more appraisal certificates/reports depicting cash values scoring the desirability of one or more human characteristics in one or more human subjects for financial gains for line of credit purposes, comprising:
a. a user logging into a system;
b. the user answering interview questions;
c. the system populating a scorecard from the answers;
d. the scorecards generating an index numbers;
e. the index numbers generating virtual models;
f. the system generating reports;
g. the system generating one or more digital appraisal certificates/reports;
h. digital appraisal certificates displaying the data as local mediums of exchange;
i. the system generating a report, including recommendations based on subject models responses to the interview questions;
j. the user uploading photos to digital appraisals certificates/reports; and
k. the user downloading a copy of the digital appraisal certificates/reports, wherein such copy can be provided for line of credit purposes.
l. The user receiving hardcopies of the digital appraisal certificates/reports

21. A computer implemented method to determine an estimated weight of a human subject's buttocks comprising:
a. a user logging into system;
b. the user entering data indicating the desirable physical characteristics of a human subject; and
c. a system using this data entered to generate an estimation of the subject's buttocks weight through one or more displacement formulas.

22. A computer implemented method of generating one or more appraisal certificates/reports depicting cash values scoring the desirability of one or more human characteristics in one or more human subjects comprising:
a. a non-user downloading the application and registers to become a user;
b. the user answering interview questions;
c. the system populating one or more scorecards from the answers;
d. the scorecards generating one or more index numbers;
e. the index numbers generating one or more virtual models;
f. the system generating one or more reports;
g. the system generating one or more digital appraisal certificates/reports wherein digital appraisal certificates display the data as monetary values;
h. the system generating one or more reports, including recommendations based on subject models responses to the interview questions;
i. the user uploading photos to one or more digital appraisals; and
j. the user downloading one or more copies of the digital appraisal certificate/reports,
k. the user downloading one or more copies of one or more digital appraisal certificates/reports,
l. the user receiving physical appraisal certificates/reports.

23. A computer implemented method for issuing twerk appraisal certificates/reports of a human subject to obtain crowdfunding comprising:
a. a user logging into a system;
b. the user uploading one or more twerk videos;
c. the system communicating with various users;
d. the users making selections on one or more scorecards that embodies the twerk proficiency of the subject;
e. the users making selections on a scorecard that identifies the physical attributes of the subject;
f. the users submitting one or more screen shots justifying scorecard selections;
g. the system creating a virtual model based upon the physical attributes selected;
h. the system generating one or more appraisal certificates;
i. the system generating one or more reports;
j. the system generating one or more digital appraisal certificates;
k. the digital appraisal certificate/report displaying data as cash values; and
l. the system generating reports including recommendations based upon user
scorecards, wherein such reports can be downloaded by the user.
m. user can receive physical appraisal certificates/reports.
